(19) United States
(12) Patent Application Publication
(10) Pub. No.: US 2007/0279390 A1
(43) Pub. Date: Dec. 6, 2007

(54) Method and apparatus for automatic screen calibration and color reproduction in a display system

(76) Inventor: Dmitrii Loukianov, Chandler, AZ (US)

Correspondence Address: INTEL CORPORATION;c/o INTELLEVATE, LLC, P.O. BOX 52050, MINNEAPOLIS, MN, 55402, US

(21) Appl. No.: 11/446,057

(22) Filed: Jun. 1, 2006

(51) Int. Cl. G09G 5/00

(52) U.S. Cl. 345/169

(57) ABSTRACT

Apparatus, systems and methods for automatic screen calibration and color reproduction in a display system are disclosed including an apparatus comprising a remote control unit where the remote control unit is capable of measuring the luminous intensity of two displayed images individually, or the difference thereof, and where the remote control unit includes logic to determine measurement data corresponding to the difference in luminous intensity of the two images, the remote control including a transmitter to transmit the measurement data. The apparatus further includes video processing logic capable of modifying image data in response to the measurement data. Other implementations are disclosed.

### BACKGROUND

Present trends toward digital high definition video and home theater displays increase the importance of tailoring video or image data to the color reproduction characteristics of a variety of different display types. Data intended for viewing on cathode ray tube (CRT) displays has traditionally been subjected to a gamma correction transfer function to account for the typical voltage-to-luminance characteristics of CRT phosphors. However, other technologies such as, for example, liquid crystal displays (LCDs) and plasma display panels (PDPs), require non-linear, multi-parameter transfer functions distinct from the typical gamma correction. Moreover, some non-CRT displays may age enough during their product life cycles to necessitate modification of the applied transfer functions if optimal color reproduction is to be maintained. It is not realistic, however, to expect the display user, who usually chooses the display type and make, to also supply the appropriate transfer functions or to modify those transfer functions as the display ages.

### BRIEF DESCRIPTION OF THE DRAWINGS

The accompanying drawings, which are incorporated in and constitute a part of this specification, illustrate one or more implementations consistent with the principles of the invention and, together with the description, explain such implementations. The drawings are not necessarily to scale, the emphasis instead being placed upon illustrating the principles of the invention. In the drawings,

FIG. 1 is a block diagram illustrating an example system in accordance with some implementations of the invention;

FIGS. 2A and 2B are block diagrams illustrating portions of systems in accordance with some implementations of the invention;

FIGS. 3A and 3B are block diagrams illustrating remote controls in accordance with some implementations of the invention;

FIG. 4 is a flow chart illustrating a process in accordance with some implementations of the invention;

FIG. 5 is a flow chart illustrating a portion of the process of FIG. 4 in greater detail in accordance with some implementations of the invention;

FIG. 6 is a flow chart illustrating a portion of the process of FIG. 4 in greater detail in accordance with some implementations of the invention; and

FIG. 7 illustrates a representative scheme useful for discussing portions of the process of FIG. 4.

### DETAILED DESCRIPTION

The following description refers to the accompanying drawings. Among the various drawings the same reference numbers may be used to identify the same or similar elements. While the following description provides a thorough understanding of the various aspects of the claimed invention by setting forth specific details such as particular structures, architectures, interfaces, techniques, etc., such details are provided for purposes of explanation and should not be viewed as limiting. Moreover, those of skill in the art will, in light of the present disclosure, appreciate that various aspects of the invention claimed may be practiced in other examples or implementations that depart from these specific details. At certain junctures in the following disclosure descriptions of well known devices, circuits, and methods have been omitted to avoid clouding the description of the present invention with unnecessary detail.

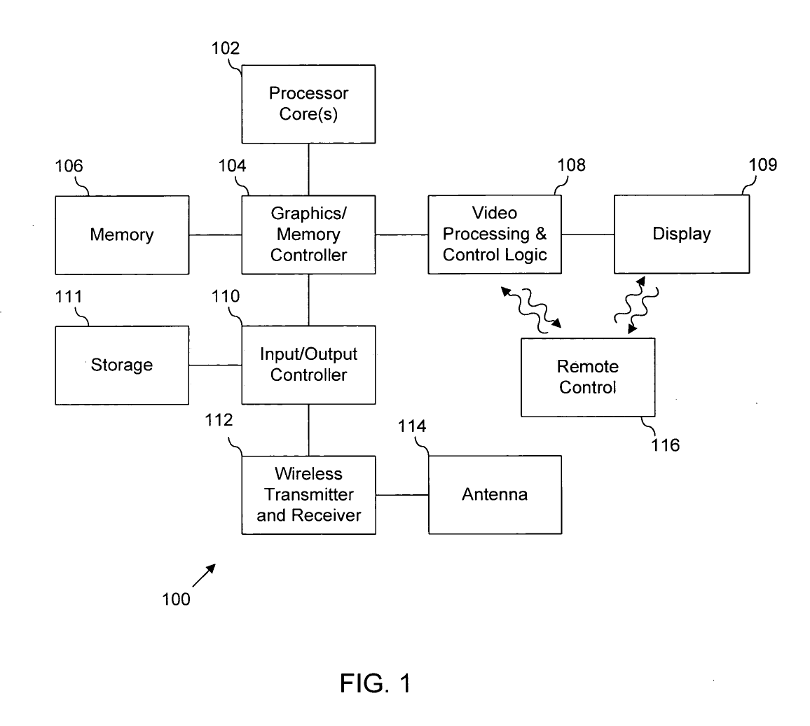

FIG. 1 illustrates an example system 100 according to some implementations of the invention. System 100 includes one or more processor core(s) 102 coupled to a graphics/memory controller 104 in addition to memory 106 (e.g., dynamic random access memory (DRAM), static random access memory (SRAM), flash, etc.), video processing and control logic (VPCL) 108, a display 109, and an input/output (I/O) controller 110 all coupled to controller 104. System 100 also includes storage 111 coupled to I/O controller 110, wireless transmitter circuitry and wireless receiver circuitry 112 coupled to I/O controller 110 and an antenna 114 (e.g., dipole antenna, narrowband Meander Line Antenna (MLA), wideband MLA, inverted “F” antenna, planar inverted “F” antenna, Goubau antenna, Patch antenna, etc.) coupled to circuitry 112. Storage 111 may comprise any non-volatile information or data storage device or devices such as Flash memory, and/or a hard disk drive to name a few examples. System 100 further includes a remote control module or unit 116 optically coupled to display 109 and/or VPCL 108.

System 100 may assume a variety of physical implementations. For example, system 100 may be implemented in a set top box (STB), personal computer (PC), a networked PC, a media PC, a server computing system, a handheld computing platform (e.g., a personal digital assistant (PDA)), a gaming system (portable or otherwise), a 3D capable cellular telephone handset, etc. Moreover, while some components of system 100 may be implemented within a single device, such as a system-on-a-chip (SOC) integrated circuit (IC), components of system 100 may also be distributed across multiple ICs or devices. For example, processor core(s) 102, controllers 104/110, memory 106, circuitry 112 and antenna 114 may be implemented, in part, as multiple ICs contained within a single computing platform, such as a media PC or a STB to name a few examples. While VPCL 108 may also be implemented along with items 102-106 and 110-114 within a PC, STB or similar platform, it may, alternatively, also be implemented in display 109.

Processor core(s)102 may comprise special purpose or general purpose processor core (s) including any control and/or processing logic, hardware, software and/or firmware, capable of providing graphics/memory controller 104 with graphics data and/or instructions. Software applications executing on system 100 may use processor core(s) 102 to perform a variety of graphics calculations or processes such as rendering image data, etc. the results of which may be provided to graphics/memory controller 104 and/or that may be stored in memory 106 for eventual provision to or use by VPCL 108.

Processor core(s) 102 may further be capable of performing any of a number of tasks that support methods and apparatus for automatic screen calibration and color reproduction in a display system. These tasks may include, for example, although the invention is not limited in this regard, providing graphics data to graphics/memory controller 104, downloading microcode to controller 104, initializing and/or configuring registers within controller 104, interrupt servicing, etc. While FIG. 1 may be interpreted as showing processor core(s) 102 and controller 104 as distinct ICs, the invention is not limited in this regard and those of skill in the art will recognize that processor core(s) 102 and controller 104 and possibly additional components of system 100 such as I/O controller 110 may be implemented within a single IC.

Graphics/memory controller 104 may comprise any processing logic, hardware, software, and/or firmware, capable of processing or controlling graphics or image data supplied to VPCL 108 and/or memory 106. Graphics processor 104 may receive graphics or image data specifying color images from processor core(s) 102, or from elsewhere in system 100 such as storage 111, and may supply that color image data to VPCL 108 for processing with, for example, pre-distortion corrections as will be described in greater detail below.

VPCL 108 may comprise any image or video processing logic, hardware, software, and/or firmware, capable of converting color image data supplied by graphics/memory controller 104 into a format suitable for driving a display (i.e., display-specific data). For example, controller 104 may retrieve graphics data from memory 106 and provide that data to VPCL 108 in a specific color data format, for example in a compressed red-green-blue (RGB) pixel format, and VPCL 108 may process that RGB data by generating, for example, corresponding LCD drive data levels, etc. VPCL 108 may do so by using color component (e.g., RGB) lookup tables. Moreover, while the invention is not limited in this regard, VPCL 108 may also undertake a variety of other image processing functions such as image scaling, alpha blending, etc.

In accordance with some implementations of the invention, and as will be described in greater detail below, VPCL 108 may modify the color image data using a pre-distortion correction scheme to modify the signals (e.g., video signal) conveying image or video data to display 109. In doing so, VPCL 108 may use logic, implemented in hardware, software, firmware or any combination thereof to modify the image data. Such a pre-distortion correction scheme may be used to produce one or more display-specific transfer functions as will be explained in greater detail below.

Further, while FIG. 1 shows controller 104 and VPCL 108 as distinct components, the invention is not limited in this regard, and those of skill in the art will recognize that, for example, some if not all of the functionality of VPCL 108 may be provided by controller 104 or processor core(s) 102 or in control logic and processing logic that is not organized into a discrete processor or controller. Moreover, while the functionality of VPCL 108 may be provided by a discrete processor or controller IC, such as a display processor IC, the invention is not limited in this regard, and those of skill in the art will recognize that the functionality of VPCL may be implemented in whole or part in display 109.

Display 109 is not limited to a particular type of display technology and may be implemented as a direct view liquid crystal display (LCD), a projection LCD, a plasma display panel (PDP), a digital light processing (DLP) projection display (CRT, laser or otherwise), a light-emitting diode (LED) panel display, a vacuum fluorescent display (VFD), an electroluminescent (EL) display, or a field-emission display (FED) to name some more common examples.

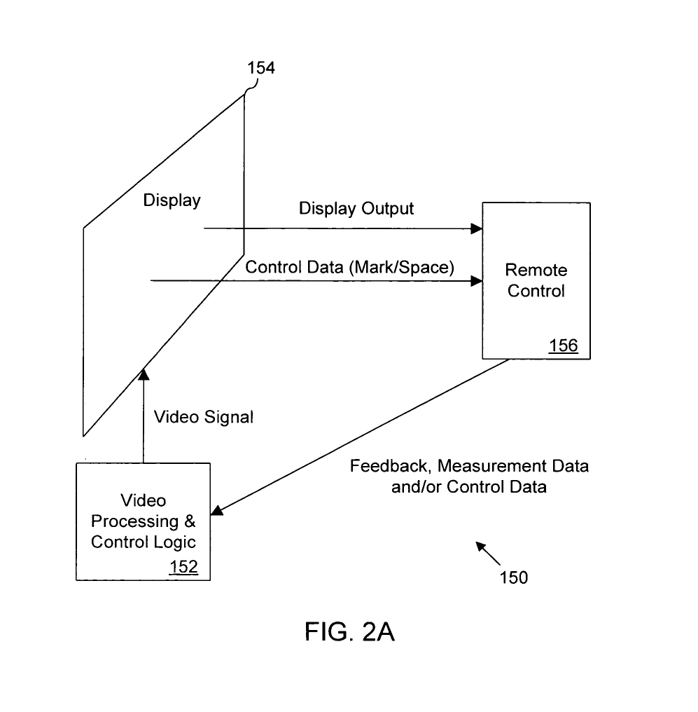

FIG. 2A illustrates a system 150 in accordance with some implementations of the invention including VPCL 152, a display 154 and remote control unit 156. System 150 may be similar to portions of system 100 of FIG. 1. In other words, VPCL 152 may be similar to VPCL 108, display 154 may be similar to display 109, and remote 156 may be similar to remote 116. Display 154 may be any type of display that is, in accordance with some implementations of the invention, at least capable of providing optical illumination including digital modulation of illumination sequences conveying control data to remote control 154. For example, in some implementations of the invention, as will be explained in greater detail below, display 154 may be capable of conveying binary encoded optical control data to remote 156 where that data conforms to well known mark/space signaling schemes or techniques, such as, for example, a data format that conforms with the well known RS-232 interface or with well known infrared remote signaling schemes. Such mark/space modulation schemes may include amplitude modulation (AM), phase modulation (PM), pulse width modulation (PWM) or pulse position modulation (PPM). Display 154 may receive the control data from VPCL 152 or from, for example, processor core(s) 102 via controller 104 and VPCL 152 and convey that data to remote 156.

In accordance with some implementations of the invention VPCL 152 may reside within a device such as a STB or a media PC and remote 156 may be capable of communicating feedback, measurement data and/or control data to VPCL 152. Thus, remote 156 may be associated with and may control the device (e.g., STB) that includes VPCL 152. VPCL 152 may receive measurement data from remote 156 conveyed using well known infrared (IR) or radio frequency (RF) signaling schemes or techniques. For example, remote 156 may provide feedback, measurement data and/or control data to VPCL 152 using the well known Philips™ RC6 protocol that, those skilled in the art will recognize, provides extension codes that may be used to encode the feedback, measurement data and/or control data. However, the invention is not limited in this regard and other IR/RF remote control protocols may be utilized by, for example, defining additional bit fields in the communication bursts, or by defining escape codes that use existing message layouts to convey feedback, measurement data and/or control data.

FIG. 2B illustrates a system 160 in accordance with some implementations of the invention including VPCL 162, a display 164 and remote control unit 166. System 160 may be similar to portions of system 100 of FIG. 1. In other words, VPCL 162 may be similar to VPCL 108, and display 164 may be similar to display 109. However, system 160 may be distinct from systems 150 or 100 in that VPCL 162 may, in accordance with some implementations of the invention, reside within or be directly associated with display 164 and remote 166 may be capable of communicating feedback, measurement data and/or control data to VPCL 162 via display 164. Thus, remote 166 may be associated with and may control display 164 in addition to conveying feedback, measurement data and/or control data to VPCL 162 via display 164.

Display 164 may be any type of display that is, in accordance with some implementations of the invention, at least capable of providing optical illumination including illumination sequences conveying control data to remote control 166 and of receiving measurement data and/or control data from remote 166. In some implementations of the invention, as will be explained in greater detail below, display 164 may be capable of conveying binary encoded optical control data to remote 166 where that data conforms to well known mark/space optical signaling schemes or techniques. Display 164 may receive the control data from VPCL 162 or from processor core(s) 102 via controller 104 and VPCL 162 and convey that data to remote 166. Further, display 164 may receive measurement data from remote 166 conveyed using well known IR or RF signaling schemes or techniques.

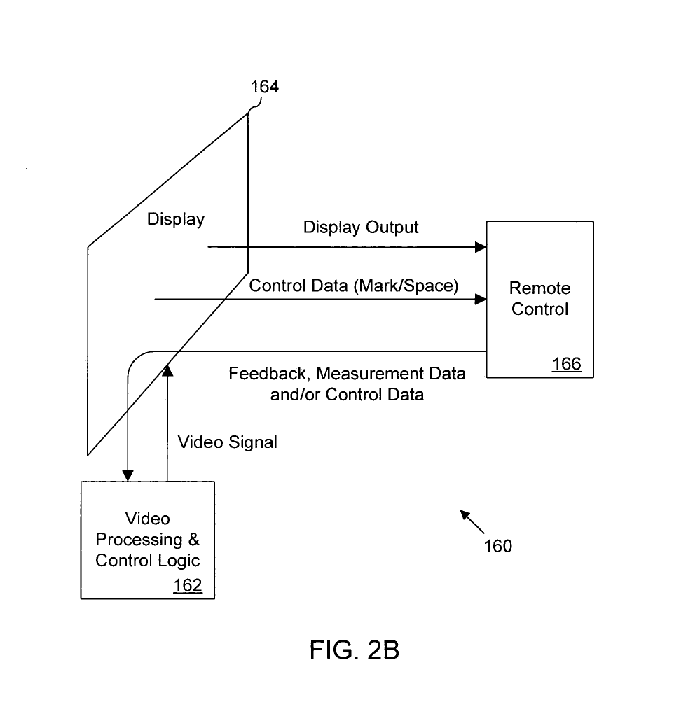

FIG. 3A illustrates portions of a remote control 200, such as remote 116 of system 100, or remotes 156/166 of systems 150/160 in accordance with some implementations of the invention. Remote 200 includes a lens 202 for conveying light output from a display, such as display 109 of system 100, to a photo sensor (e.g., a photodiode) 204. The analog output of sensor 204 feeds an analog-to-digital (A/D) converter 206 to produce digitized data that is in turn sampled by a controller 208. Remote 200 further includes a memory 210 and a transmitter 212 both coupled to controller 208. Controller 208 also includes control logic 214 and processing logic 216. While controller 208 may be a discrete IC, the invention is not limited in this regard and those skilled in the will recognize that the functionality of controller 208 including control logic 214 and processing logic 216 may be distributed across one or more ICs. Further, those skilled in the art will recognize that remote 200 may include additional elements, such as a lens housing assembly, additional optics, other circuitry, a power source, etc. that are not particularly germane to the invention and hence that have been excluded from FIG. 3A in the interest of clarity.

In some implementations of the invention, memory 210 may be a read only memory (ROM) that stores software algorithms, routines and/or instructions to be implemented or run by controller 208. In some implementations of the invention, sensor 204 may be an uncompensated photodiode and memory 210 may store calibration data that may be used by controller 208 to compensate the output of sensor 204 or converter 206. In doing so, controller 208 may use logic, implemented in hardware, software, firmware or any combination thereof to compensate the output of sensor 204 or converter 206. Those skilled in the art will recognize that an uncompensated photodiode may comprise a photodiode lacking spectral correction.

In some implementations of the invention, transmitter 212 may be a unidirectional IR or RF transmitter that conveys measurement data generated by controller 208 to display 209 using well known IR or RF signaling schemes or methods. Display 209 may then convey that measurement data to VPCL 108 and/or processor core(s) 102. The functionality of remote 200 as described herein may be provided by remote 116 of FIG. 1, remote 156 of FIG. 2A, or remote 166 of FIG. 2B.

FIG. 3B illustrates portions of another remote control 300 in accordance with some implementations of the invention. Remote 300 may be similar to remote 200 of FIG. 3A, except that remote 300 includes synchronous demodulation logic 302 that may be capable of implementing well-known synchronous demodulation techniques to modulate the output of a photo sensor 304 (e.g., similar to photo sensor 204), where sensor 304's output correlates directly to the illumination intensity of the display's optical output, with a reference signal corresponding to or derived from the frame rate of the display (e.g., display 109). Although the invention is not limited in this regard, the frame rate of display 109 may be communicated to remote 300 using well known mark/space techniques as will be discussed in greater detail below.

Remote 300 further includes an integrator 306 that integrates the output of logic 302 and supplies an integrated analog signal to an A/D converter 308 which feeds a controller 310 with digitized data samples. Controller 310 also includes control logic 316 and processing logic 318. While controller 310 may be a discrete IC, the invention is not limited in this regard and those skilled in the will recognize that the functionality of controller 310 including control logic 316 and processing logic 318 may be distributed across one or more ICs. Remote 300 further includes memory 312, a transmitter 314 and a lens assembly 316 similar to memory 210, transmitter 212 and lens assembly 202 of remote 200 as described above.

Those skilled in the art will recognize that synchronous demodulation undertaken by remote 300 may permit that portion of the output of sensor 304 corresponding to light emitted by the display to be decoupled from that portion corresponding to ambient light detected by sensor 304 (i.e., that portion of the sensor's response that is not derived from light emitted by the display). Thus, in accordance with some implementations of the invention, the output of demodulation logic 302 may comprise substantially only that portion of sensor 304's response that results from illumination by a display and not from illumination from other light sources that may be present in the vicinity of remote 300 and/or system 100. The functionality of remote 300 as described herein may be provided by remote 116 of FIG. 1, remote 156 of FIG. 2A, or remote 166 of FIG. 2B.

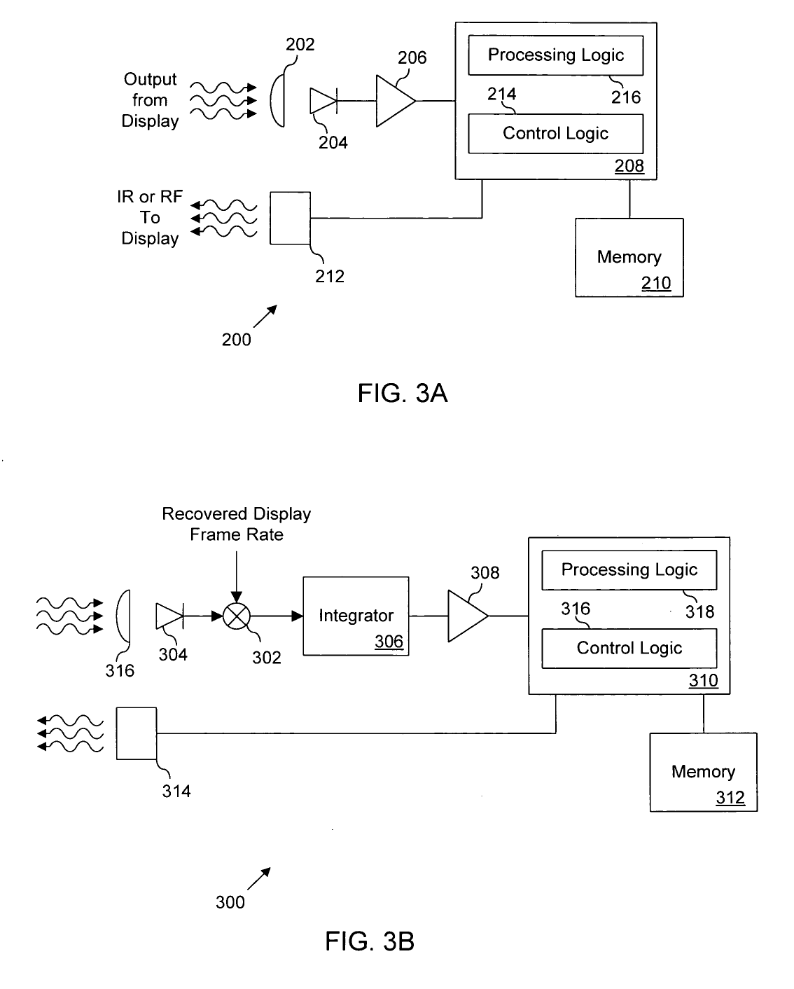

FIG. 4 illustrates a process 400 for automatic screen calibration and color reproduction in a display system in accordance with some implementations of the invention. While, for ease of explanation, process 400, and associated processes, may be described with regard to systems 100, 150 or 160 of FIGS. 1-2A/B, or remotes 200/300 of FIGS. 3A/B, the invention is not limited in this regard and other processes or schemes supported and/or performed by appropriate devices and/or combinations of devices in accordance with the invention are possible.

Process 400 may begin with the initiation of a calibration scheme [act 401]. In some implementations of the invention, a user of system 100 may undertake act 401 by selecting a video calibration mode using remote 200/300. In doing so, assuming remote 200 is pointed at display 109 so that transmitter 212 may communicate data to a receiver (not shown) in display 109, controller 208 may implement act 401 by using transmitter 212 to provide data to display 109 and hence to VPCL 108. That data may then instruct VPCL 108 to initiate a calibration scheme as will be described below. Systems using remote 300 may implement a similar series of acts. Alternatively, in a system such as system 150, remote 166 may implement act 401 by providing control data directly to VPCL 162.

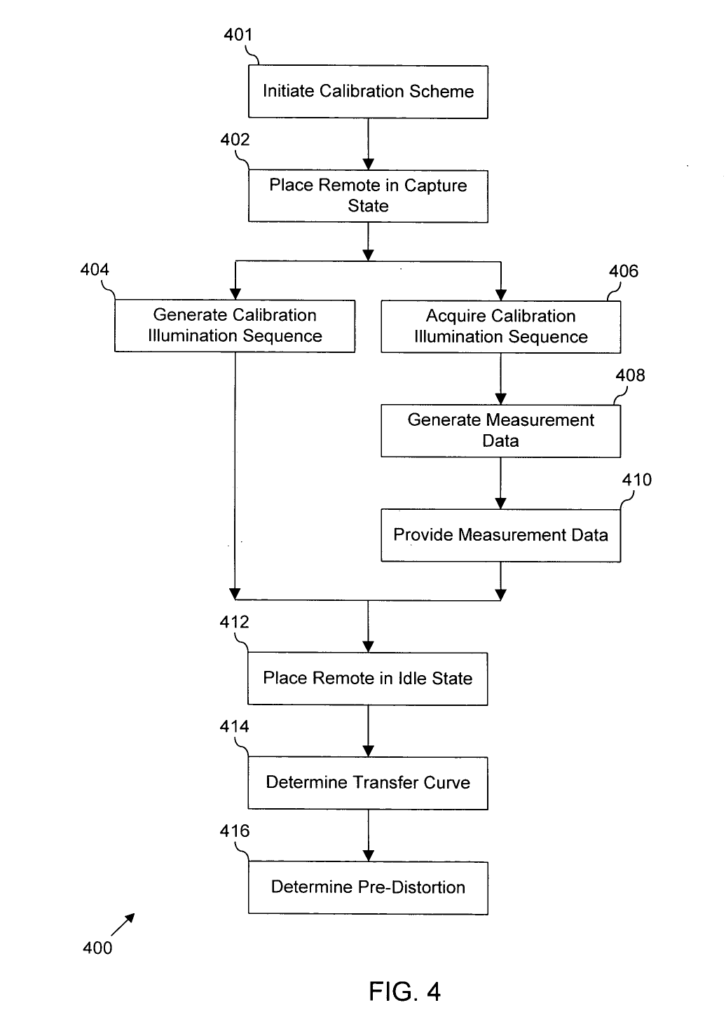

Process 400 may continue with the placement of the remote in a capture state [act 404]. FIG. 5 illustrates a process 500 for configuring a remote control, such as placing a remote in a capture state in act 402 of process 400, in accordance with some implementations of the invention. While, for ease of explanation, process 500, and associated processes, may be described with regard to system 100 of FIG. 1, systems 150/160 of FIGS. 2A/B, or remotes 200/300 of FIGS. 3A/B, the invention is not limited in this regard and other processes or schemes supported and/or performed by appropriate devices and/or combinations of devices in accordance with the invention are possible.

Process 500 may begin with the transmission of a mark/space sequence to a remote [act 502]. In some implementations of then invention act 502 may be undertaken by having VPCL 108 use display 109 to provide a pre-defined mark/space illumination sequence to remote 200. For example, act 502 may comprise display 109, in response to VPCL 108, providing a pre-determined sequence of bright white illuminations (i.e., “mark” equivalent to binary “on”) and black or no illuminations (i.e., “space” equivalent to binary “off”) to remote 200.

Process 500 may continue with the acquisition of the mark/space sequence [act 504] and the decoding of that mark/space sequence [act 506]. In some implementations of the invention, sensor 204 and A/D converter 206 or remote 200 may undertake act 504 by converting the mark/space illumination sequence into a binary data sequence and provide that sequence to controller 208 where that sequence conveys control data to controller 208. In some implementations of the invention, act 506 may comprise controller 208 decoding the binary data sequence to recover the control data.

Process 500 may then conclude with the configuration of the remote [act 508] in response to the control data conveyed by the mark/space illumination sequence. This may be done by having controller 208, in response to the control data, execute a software algorithm or routine obtained from memory 210 where that algorithm or routine acts to place remote 200 in a capture state. The capture state may enable the remote to undertake acts 406-410 to be described further below. The acts described above for process 500 in the context of remote 200 may be performed in a similar manner by remote 300.

Returning to FIG. 4, process 400 may continue with the generation of a calibration illumination sequence [act 404] and the acquisition of that calibration illumination sequence [act 406]. In some implementations of the invention, act 404 may be undertaken by VPCL 108 employing display 109 to generate a sequence of different colors at various luminosity levels or luminous intensities. Those skilled in the art will recognize that the illumination sequence generated in act 404 may comprise a sequence of different colors at various luminosity levels that uniformly fill the display screen of display 109 so that the subsequent acquisition of that illumination sequence by, for example, remote 116 is as independent as possible from the accuracy with which that remote is oriented by a user in the direction of the display screen of display 109.

In some implementations of the invention, remote 200 may undertake act 406 by lens 202 supplying the display output to sensor 204, and converter 206 digitizing the output of sensor 204 and then supplying the digitized results to controller 208. By contrast, in other implementations of the invention, remote 300 may undertake act 406 by demodulation logic 302 synchronously demodulating the output of sensor 304 with the recovered display frame rate as conveyed to remote 300 using mark/space techniques, integrator 306 supplying converter 308 with the integrated output of demodulation logic 302 and converter 308 supplying controller 310 with the digitized data sequence corresponding to the illumination sequence.

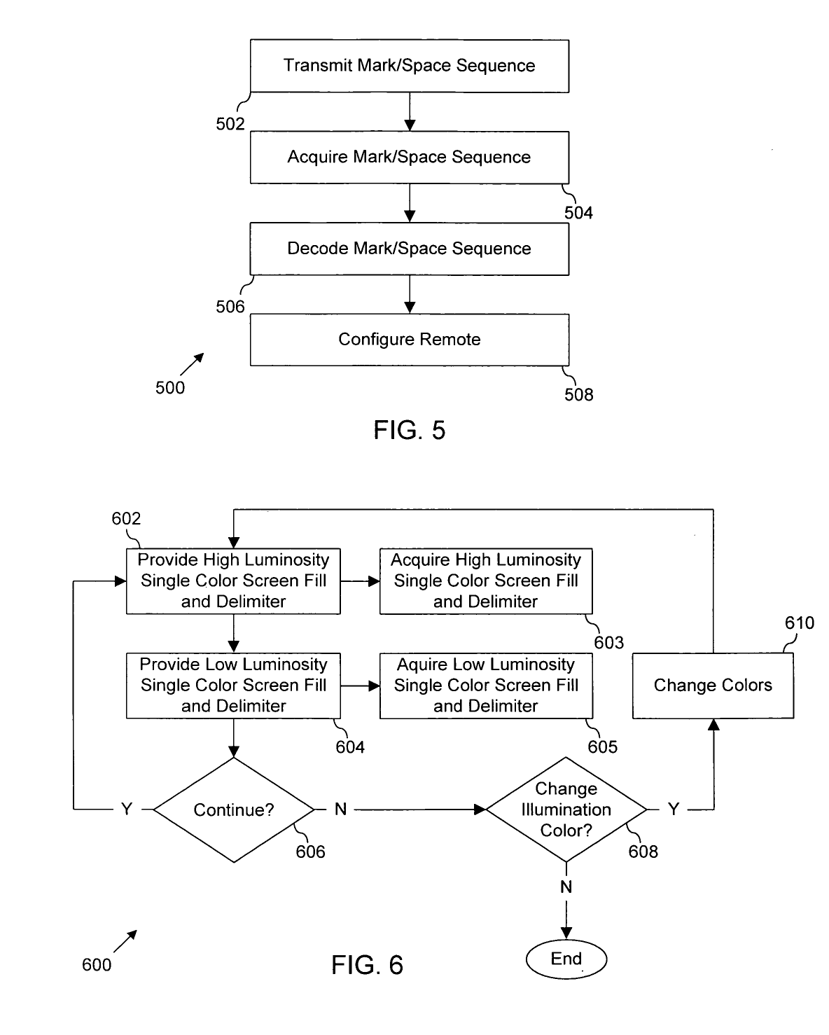

FIG. 6 illustrates a process 600 for generating calibration illumination sequence in accordance with some implementations of acts 404 and 406 of process 400. While, for ease of explanation, process 600, and associated processes, may be described with regard to system 100 of FIG. 1, systems 150/160 of FIGS. 2A/B, or remotes 200/300 of FIGS. 3A/B, the invention is not limited in this regard and other processes or schemes supported and/or performed by appropriate devices and/or combinations of devices in accordance with the invention are possible. [00391 Process 600 may begin with the provision of a high luminosity single color screen fill and delimiter [act 602]. In some implementations of the invention, act 602 may be undertaken by VPCL 108 supplying display 109 with image data that causes display 109 to emit high luminosity light in a single color such that the display screen of display 109 is uniformly filled with that color preceded or followed by a delimiter comprising a mark/space sequence. For example, act 602 may result in display 109 uniformly filling its display screen with a single color, such as red, at 90% of maximum luminosity or luminous intensity followed by a mark/space sequence conveying information such as data specifying the test number associated with that high luminosity single color screen fill. In accordance with some implementations of the invention employing a remote like remote 300, the mark/space sequence may also convey the frame rate of display 109 to that remote so that synchronous demodulation techniques may be employed in act 406.

Process 600 may continue with the acquisition of the high luminosity single color screen fill and delimiter [act 603]. In some implementations of the invention, referring, for example, to the implementation of remote 200, act 603 may be undertaken by the combination of lens 202, sensor 204 and converter 206 supplying controller 208 with a digitized data sequence corresponding to the luminous intensity of the single color screen fill as well as the delimiter provided in act 602.

Process 600 may continue the provision of a low luminosity single color screen fill and delimiter [act 604] and the acquisition of that low luminosity single color screen fill and delimiter [act 605]. In some implementations of the invention, VPCL 108 and display 109 along with remote 200 may undertake acts 604 and 605 in essentially the same manner that acts 602 and 603 are undertaken using the same color employed in act 602 with the exception that the luminous intensity provided in act 604 is less that the luminous intensity provided in act 602. For example, while act 602 may provide a 90% red luminosity screen fill, act 604 may provide a 10% red luminosity screen fill. Clearly many different combinations of different luminous intensities may be provided in acts 602 and 604 and the invention is not limited to any particular combination of different luminous intensities or to the use of a specific color. For example, act 602 may provide a 50% luminosity blue screen fill and act 604 may provide a 10% luminosity blue screen fill. Neither is the invention limited to two different luminous intensities as shown in FIG. 6. For example, three different luminous intensities such as 90%, 50% and 10% could be employed in three separate illumination acts.

Process 600 may continue with a determination of whether to continue with additional repetitions of acts 602 and 604 [act 606]. In accordance with some implementations of the invention, the determination of act 606 may be undertaken by VPCL 108 when initiated to undertake the calibration scheme in act 401. In other words, when undertaking the calibration scheme, VPCL 108 may use display 109 to undertake acts 602 and 604 a certain number of times. For example, although the invention is not limited in this regard, VPCL 108 may provide display 109 with image data to undertake both acts 602 and 604 a total of sixteen times. In such case the outcome of act 606 would be positive and acts 602 and 604 would repeat.

On the other hand, if the outcome of act 606 is negative, then process 600 may continue to a determination of whether to change the illumination color [act 608]. In some implementations of the invention, VPCL 108 may undertake the determination of act 608 according to the calibration scheme initiated in act 401 of FIG. 4. If the outcome of act 608 is negative, that is if the illumination color is not to be changed, then process 600 may end. Otherwise, if the outcome of act 608 is positive, that is if the illumination color is to be changed, then process 600 may continue with a change of colors [act 610]. In other words, when undertaking the calibration scheme, VPCL 108 may provide display 109 with image data to undertake acts 602 and 604 a certain number of times in a first color (e.g., red), and then, in act 610, provide display 109 with image data specifying a different illumination color (e.g., blue).

Process 600 may then continue with acts 602-606 being undertaken with the new fill color along the same lines as discussed above. For example, although the invention is not limited in this regard, VPCL 108 may provide display 109 with image data to undertake both acts 602 and 604 using a blue fill color a total of sixteen times with 90% illumination in acts 602 and 10% illumination in acts 604. At the next occurrence of act 608, process 600 may continue, for example, with a change to green fill color. Acts 602-606 may then be undertaken with the green fill color along the same lines as discussed above. Clearly, process 600 may continue until act 608 results in a negative determination. Again, however, the invention is not limited to a particular number of illumination events, particular sequences of colors or to particular illumination levels.

Returning to FIG. 4, process 400 may continue with the generation of measurement data [act 408] based on that calibration illumination sequence. For example, for each set of high illumination and low illumination data acquisitions (e.g., acts 603/605 of FIG. 6), controller 310 of remote 300 of FIG. 3B may determine the difference between the measured luminosity of the two corresponding luminosities provided to controller 310 by the data acquisition elements comprising items 302-308. Alternatively, remote 200 of FIG. 3A could undertake a similar measurement scheme for act 408 using data acquisition elements comprising items 202-206.

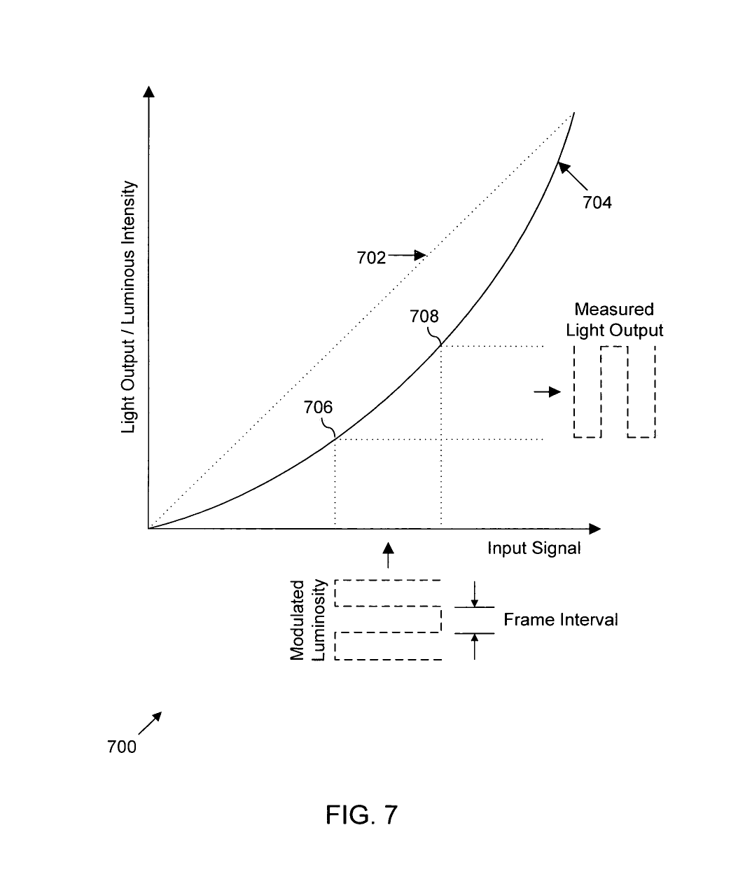

FIG. 7 illustrates a representative scheme 700 and related quantities useful for discussing act 408 in accordance with some implementations of the invention. Scheme 700 includes a plot of display light output or luminous intensity (e.g., from display 109) versus input signal driving the display (e.g., as provided by VPCL 108) for a given fill color. A display transfer function 702 represents a desired display transfer function where the signal driving the display has a linear relationship to the resulting display output. Actual hardware transfer function 704 represents a typical non-linear transfer curve. Function 704 includes two measured luminous intensity data points 706 and 708 as may correspond to one instance of the acquisitions of acts 603 and 605 respectively. Thus, referring also to FIG. 4, act 408 may involve controller 310 obtaining the luminous intensity corresponding to data points 706 and 708, from which processing logic 318 may compute the difference between those two, measured luminous intensities. Controller 310 may do so in response to instructions provided by an algorithm loaded from memory 312. While FIG. 7 shows two luminous intensity measurements (data points 706 and 708) for a given color fill, the invention is not limited in this regard and those skilled in the art will recognize that more than two luminous intensity measurements may be made for a given hardware transfer curve.

Process 400 may continue with the provision of the measurement data [act 410]. In accordance with some implementations, act 410 may be undertaken by, for example, controller 310 conveying measurement data corresponding to the difference between the two, measured luminous intensities (e.g., as acquired in acts 603/605) to display 109 using well known IR or RF communication techniques. In some implementations, act 410 may be undertaken immediately after each pair of acquisition events (e.g., acts 603/605). The invention is not limited in this regard however, and, in other implementations, act 410 may occur at other intervals or may take place after all acquisition events have occurred. In a system such as system 150 of FIG. 2A, act 410 may be undertaken by remote 156 conveying measurement data directly to VPCL 152. Alternatively, in a system such as system 160 of FIG. 2B, act 410 may be undertaken by remote 166 conveying measurement data to VPCL 162 via display 164.

Process 400 may continue with the placement of the remote in an idle state [act 412]. In some implementations of the invention, VPCL 108 may, after all measurement data has been acquired and provided (acts 408/410) use display 109 to convey control data in the form of a mark/space sequence to remote 116 where that control data acts to place remote 116 in an idle state. Thus, in accordance with some implementations of the invention, act 410 may involve removing remote 116 from the capture state that the remote was placed in by act 402.

Process 400 may continue with the determination of a hardware transfer curve [act 414]. In some implementations of the invention, act 414 may be undertaken by VPCL 108 in response to instructions issued by an algorithm executing on VPCL 108. For example, an algorithm may instruct VPCL 108 to approximate a hardware transfer function (e.g., curve 704) by fitting the measurement data provided in act 410 (e.g., luminous intensity data points 706 and 708) to a parametric function. However, the invention is not limited to a particular method for determining the transfer curve in act 414, and, further, those skilled in the art will recognize that a variety of parametric functions, such as polynomial functions, may be employed in act 414.

Process 400 may conclude with the determination of a pre-distortion correction [act 416]. In accordance with some implementations of the invention, a software algorithm executing on VPCL 108 may calculate a pre-distortion correction based on the hardware transfer curve determined in act 414 such that a corrected display transfer function provided by display 109 may more closely approximate the desired linear display transfer function (e.g., curve 702). In some implementations of the invention, act 416 may involve the calculation of a set of pre-distortion corrections that can be applied to, for example, the color component (RGB) lookup tables used by VPCL 108 to determine appropriate image data to be provided to display 109 (e.g., in the form of a video signal), or applied to other means of programmable pre-distortion in the image data path between VPCL 108 and display 109.

The acts shown in FIGS. 4-6 need not be implemented in the order shown; nor do all of the acts necessarily need to be performed. Also, those acts that are not dependent on other acts may be performed before or in parallel with the other acts. For example, acts 408 (generate measurement data) and 410 (provide measurement data) associated with a specific portion of the illumination sequence of act 404 (generate calibration illumination sequence) in one color (e.g., one or more iteration of acts 602 and 604 in one fill color) may be undertaken in parallel with another portion of the illumination sequence of act 404 in another color (e.g., one or more iteration of acts 602 and 604 in another fill color). Further, at least some of the acts in FIGS. 4-6 may be implemented as instructions, or groups of instructions, implemented in a machine-readable medium.

In accordance with some implementations of the invention as described above, an automatic color adjustment system may be capable of collecting information about the display transfer function at a given level of ambient light and different display light output intensities. The system may then apply the measurements to pre-distort the signal driving the display to create a more or less linear transfer function. The automatic color adjustment system can be started by a user at any time, such as when the ambient light environment substantially changes or at installation time. Such a system may automatically provide improved video fidelity from a user's current viewing position and/or a given ambient light level without requiring the user to select pre-distortion parameters.

The foregoing description of one or more implementations consistent with the principles of the invention provides illustration and description, but is not intended to be exhaustive or to limit the scope of the invention to the precise form disclosed. Modifications and variations are possible in light of the above teachings or may be acquired from practice of various implementations of the invention. For example, it may be necessary in the course of undertaking of acts 406-408 to measure ambient light level in the vicinity of remote 116 and include that measurement as a parameter in the calculation of desired initial screen brightness and correction. This may be done, for example, by incorporating in remote 116 a conventional light measuring device and providing the output of that device to the remote's controller IC. In addition, while process 400, as described above, has a controller in remote 116 perform the act of generating measurement data (act 408) this act could also be undertaken by, for example, VPCL 108 in response to illumination data provided to VPCL 108 by remote 11.6. Clearly, many other implementations may be employed to provide a method, apparatus and/or system to implement automatic screen calibration and color reproduction in a display system consistent with the claimed invention.

No element, act, or instruction used in the description of the present application should be construed as critical or essential to the invention unless explicitly described as such. Also, as used herein, the article “a” is intended to include one or more items. In addition, some terms used to describe some implementations of the invention, such as “image data” and may be used interchangeably with “video data” in some circumstances. Moreover, when terms such as “coupled” or “responsive” are used herein or in the claims that follow, these terms are meant to be interpreted broadly. For example, the phrase “coupled to” may refer to being communicatively, electrically and/or operatively coupled as appropriate for the context in which the phrase is used. Variations and modifications may be made to the above-described implementation(s) of the claimed invention without departing substantially from the spirit and principles of the invention. All such modifications and variations are intended to be included herein within the scope of this disclosure and protected by the following claims.

What is claimed:

1. A method comprising:
using a display to provide at least first and second images in a first color, the first and second images provided at different luminous intensities; and
using a remote control unit to acquire the luminous intensities of the first and second images, or the difference thereof.

2. The method of claim 1, further comprising:
using logic in the remote control unit to generate measurement data derived, at least in part, from the acquired luminous intensities of the first and second images, or the difference thereof; and
conveying the measurement data to video processing logic, the video processing logic at least capable of using the measurement data to estimate a transfer function of the display.

3. The method of claim 2, further comprising:
using the video processing logic to modify the transfer function of the display.

4. The method of claim 3, wherein using the video processing logic to modify the transfer function of the display includes applying a pre-distortion correction to a video signal.

5. The method of claim 1, wherein using a remote control unit to acquire the luminous intensities of the first and second images, or the difference thereof, includes synchronously demodulating the luminous intensities of the first and second images using the frame rate of the display as a reference signal.

6. The method of claim 1 wherein the first and second images fill the screen of the display.

7. The method of claim 1, further comprising:
using the display to provide at least third and fourth images in a second color, the third and fourth images provided at different luminous intensities; and
using the remote control unit to acquire the luminous intensities of the third and fourth images, or the difference thereof.

8. An apparatus, comprising:
a remote control at least capable of measuring the luminous intensity of two displayed images individually, or the difference thereof, the remote control including logic to determine measurement data corresponding to the difference in luminous intensity of the two images, the remote control including a transmitter to transmit the measurement data; and
video processing logic at least capable of modifying image data in response to the measurement data.

9. The apparatus of claim 8, wherein modifying image data in response to the measurement data comprises the video processing logic pre-distorting signals to be provided to a display.

10. The apparatus of claim 8, further comprising:
demodulation logic to synchronously demodulate the luminous intensity of the two displayed images or the difference thereof with a reference signal derived from the frame rate of a display that provided the two displayed images.

11. The apparatus of claim 8, wherein the video processing logic is further capable of communicating with the remote control unit using luminosity modulation of image data.

12. The apparatus of claim 11, wherein the luminosity modulation comprises mark/space modulation including one of amplitude modulation (AM), phase modulation (PM), pulse width modulation (PWM) or pulse position modulation (PPM).

13. The apparatus of claim 8, wherein the remote control is further capable of communicating with the video processing logic using infrared (IR) or radio frequency (RF) signals.

14. The apparatus of claim 8, wherein the remote control further includes:
a sensor to measure the luminous intensity of the two displayed images;
memory to store calibration data for the sensor; and
logic to use the calibration data to correct output of the sensor.

15. A system, comprising:
a display;
a remote control unit at least capable of measuring the luminous intensity of two images provided by the display or the difference thereof, the remote control unit including logic to determine measurement data corresponding to the difference in luminous intensity of the two images, the remote control unit including a transmitter to transmit the measurement data; and
video processing logic at least capable of modifying, in response to the measurement data, image data to be provided to the display.

16. The system of claim 15, wherein modifying image data in response to the measurement data comprises the video processing logic pre-distorting signals to be provided to the display.

17. The system of claim 15, further comprising:
demodulation logic to synchronously demodulate the luminous intensity of the two displayed images with a frame rate of the display.

18. The system of claim 15, wherein the video processing logic is further capable of communicating with the remote control using digital modulation of images provided by the display.

19. The system of claim 15, wherein the remote control further includes:
a sensor to measure the luminous intensity of the two displayed images;
memory to store sensor calibration data; and
logic to use the calibration data to correct output of the sensor.

20. The system of claim 15, wherein the display comprises one of a direct view liquid crystal display (LCD), a projection LCD, a plasma display panel (PDP), a digital light processing (DLP) a projection display, a light-emitting diode (LED) display, a vacuum fluorescent display (VFD), an electroluminescent (EL) display, or a field-emission display (FED).
